(19) United States
(12) Patent Application Publication
(10) Pub. No.: US 2006/0051614 A1
(43) Pub. Date: Mar. 9, 2006

(54) Organometallic complex and organic electroluminescent device utilizing the same

(75) Inventors: Ying-Ju Su, Taichung City (TW); Chung-Wen Ko, Sijhih City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/006,239

(22) Filed: Dec. 7, 2004

(30) Foreign Application Priority Data
Sep. 6, 2004 (TW) 93126854

(51) Int. Cl. H05B 33/12; C09K 11/06

(52) U.S. Cl. 428/690; 428/917; 313/504; 313/506; 257/E51.044; 546/2; 546/4; 546/5

(57) ABSTRACT

An organometallic complex having formula (I)

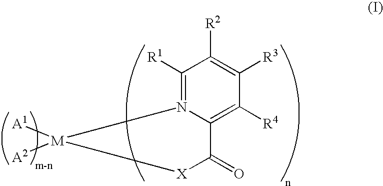

wherein M is a transition metal; A¹ and A² are each independently a monodentate ligand, or are covalently joined to form a bidentate ligand; wherein when X is oxygen, R¹, R², R³, R⁴ are each independently CN, CF₃, C₁₋₂₀ alkoxyl, or NRR′; and when X is S or NR, R¹, R², R³, R⁴ are each independently halogen, CN, CF₃, C₁₋₂₀ alkyl, C₅₋₇ aryl, C₁₋₂₀ alkoxyl, or NRR′; wherein R, R′ are each independently C₁₋₂₀ alkyl or C₅₋₇ aryl; m is the valence of M; and n is 1, 2, or 3.

### BACKGROUND

The invention relates to an organometallic complex and an organic electroluminescent device including the same.

An organic electroluminescent device (also referred to as organic light-emitting diode; OLED) is an LED with an organic layer serving as the active layer, increasingly applied in flat panel displays due to advantages such as low voltage operation, high brightness, light weight, slim profile, wide viewing angle, and highly effective contrast ratio.

Generally, an OLED is composed of a light-emitting layer sandwiched by a pair of electrodes. When an electric field is applied to these two electrodes, the cathode injects electrons into the light-emitting layer and the anode injects holes into the light-emitting layer. When the electrons recombine with the holes in the light-emitting layer, excitons are formed. Recombination of the electron and the hole generates emission.

Depending on the spin states of the hole and the electron, the exciton which results from recombination of the hole and the electron can have either a triplet or singlet spin state. Luminescence from a singlet exciton results in fluorescence whereas luminescence from a triplet exciton results in phosphorescence. The emissive efficiency of phosphorescence is three times that of fluorescence. Therefore, it is crucial to develop highly efficient phosphorescent material, in order to increase the emissive efficiency of the OLED.

### SUMMARY

Accordingly, an embodiment of a novel organometallic complex is provided. The organometallic complex is phosphorescent. The organometallic complex can emit blue light or blue phosphorescence, and can have a hole transport property.

The organometallic complex has formula (I):

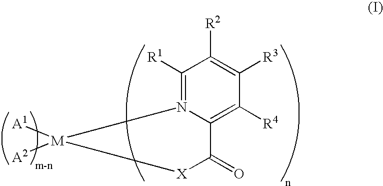

wherein

M is a transition metal;

each A¹ and A² is independently a monodentate ligand, or A¹ and A² are covalently joined together to form a bidentate ligand;

when X is oxygen,

R¹, R², R³, R⁴ are each independently CN, CF₃, C₁₋₂₀ alkoxyl, or NRR′;

when X is S or NR,

R¹, R², R³, R⁴ are each independently halogen, CN, CF₃, C₁₋₂₀ alkyl, C₅₋₇ aryl, C₁₋₂₀ alkoxyl, or NRR′;

wherein R, R′ are each independently C₁₋₂₀ alkyl, or C₅₋₇ aryl;

m is the valence of M; and

n is 1, 2, or 3.

Also provided is an organic electroluminescent device utilizing the organometallic complex, serving as a light-emitting layer.

An embodiment of the organic electroluminescent device includes a pair of electrodes and an organic light-emitting unit disposed therebetween. The organic light-emitting unit includes an organometallic complex of formula (I), and may further comprise a emissive layer, a hole transport layer, or an electron transport layer, also comprising the organometallic complex of formula (I).

### BRIEF DESCRIPTION OF THE DRAWINGS

The invention can be more fully understood and further advantages become apparent when reference is made to the following description and the accompanying drawings in which:

FIG. 1 shows a comparison of photo luminance spectrum between conventional FIrpic and embodiments of organometallic complexes, labeled compounds 1 and 2.

FIG. 2 shows a comparison of CIE coordinate between conventional FIrpic and embodiments of organometallic complexes, labeled as compounds 1 and 2.

### DETAILED DESCRIPTION

An embodiment of an organometallic complex has formula (I):

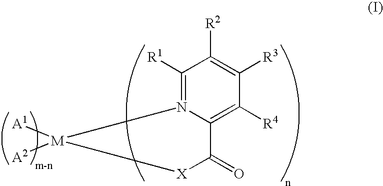

where M is a transition metal, preferably having d⁶ or d⁸ electron orbital. For example, M can be Ir, Pt, Os, Re, Ru, or Rh, preferably Ir.

A¹ and A² can independently be a monodentate ligand. Numerous monodentate ligands are known to those skilled in the art. Representative examples include F, Cl, Br, I, CO, CN, CN(R¹¹), SR¹¹, SCN, OCN, P(R¹¹ )₃, P(OR¹¹)₃, N(R¹¹)₃, NO, and N₃, wherein R¹¹ is alkyl or aryl. In addition, such suitable monodentate ligand can be a nitrogen-containing heterocycle, such as pyridine, imidazole, pyrrolidine, piperidine, morpholine, pyrimidine, pyrazine, pyridazine, pyrrole, 1,3,4-triazole, tetrazole, isoxazole, thiazole, derivatives thereof and the like.

Alternatively, A¹ and A² can be covalently joined to form a bidentate ligand. Numerous bidentate ligands are known to those skilled in the art. Suitable bidentate ligands include acetylacetonate (acac), picolinate (pic), hexafluoroacetylacetonate, 8-hydroxyquinolinate, amino acids, iminoacetonate, bipyridyl, 2-1-naphthyl) benzoxazole, 2-phenylbenzoxazole, 2-phenylbenzothiazole, thienylpyridine, phenylpyridine, benzothienylpyridine, 3-methoxy-2-phenylpyridine, tolylpyridine, vinylpyridine, arylquinolines, pyridylnaphthalene, pyridylpyrrole, pyridylimidazole, 2-(4,6-difluorophenyl)pyridine, derivatives thereof and the like, preferably 2-(4,6-difluorophenyl)pyridine.

R¹, R², R³, R⁴ are each independently halogen, CN, CF₃, C₁₋₂₀ alkyl, C₅₋₇ aryl, C₁₋₂₀ alkoxyl, or NRR′. R and R′ are each independently C₁₋₂₀ alkyl, or C₅₋₇ aryl.

When X is oxygen, R¹, R², R³, R⁴ are each independently CN, CF₃, C₁₋₂₀ alkoxyl, or NRR′.

When X is S or NR, R¹, R², R³, R⁴ are each independently halogen, CN, CF₃, C₁₋₂₀ alkyl, C₅₋₇ aryl, C₁₋₂₀ alkoxyl, or NRR′.

m is the valence of M.

n is 1, 2, or 3.

Practical examples are described herein.

### EXAMPLES

The following examples disclose preparation of embodiments of an organometallic complex, referred to respectively as compounds 1 and 2. While two suitable examples are disclosed here, it should be noted that other applications are equally suitable, and there is no intention to limit the disclosure thereto. Chemical structures of the disclosed compounds follow.

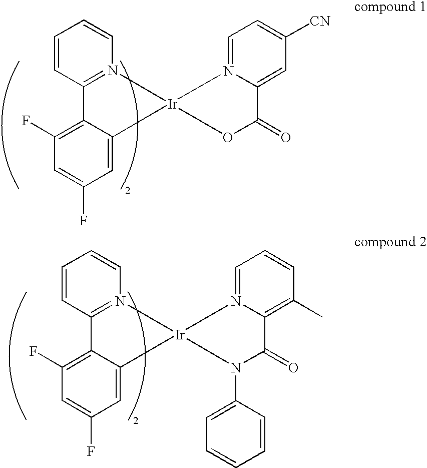

### Example 1

### Synthesis of Iridium(III)bis[2-(4,6-difluorophenyl)pyridine](4-cyano-2-picolinate) (Compound 1)

Step 1:

4-cyanopyridine (1.00 g, 9.61 mmol) dissolved in 25 ml of tetrahydrofuran (THF) was charged in a dried 50 ml two-neck bottle, diethylcarbonate (1.48 g, 12.53 mmol) was added, and the mixture was cooled to −78° C. Tert-butyl lithium (6.2 ml, 10.54 mmol, dissolved in 1.7M pentane) was slowly added to the 50 ml two-neck bottle. The mixture was re-warmed, and the reaction conducted for 8 hours and terminated by water. pH value was adjusted by 10% HCl to weak acidity. The product was extracted by ethyl ether and water, and the organic layer dried and purified by column chromatography to obtain 4-cyano-2-picolinic acid with a yield of 15%. The synthesis pathway is shown.

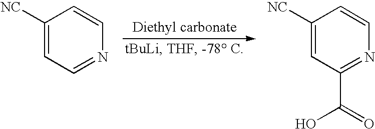

Step 2:

Dichloro bridged dimmer: [IrCl(2-(4,6-difluorophenyl) pyridine)₂]₂ (1.00 g, 0.82 mmol), 4-cyano-2-picolinic acid (0.32 g, 2.16 mmol) and Na₂CO₃ (0.96 g, 9.06 mmol) were mixed and refluxed with 20 ml of ethylene glycol ethyl ether for 24 hours. A precipitate was formed by water and washed with water and hexane several times. After drying, compound 1 was obtained at a yield of 15%. The synthesis pathway is shown.

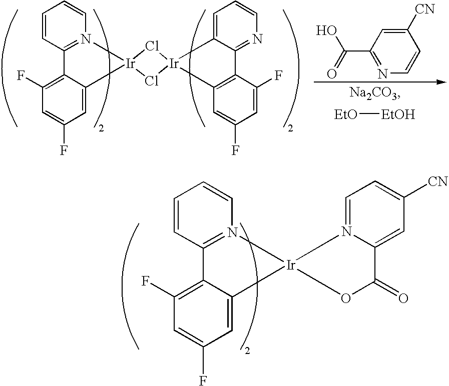

### Example 2

### Synthesis of Iridium(III)bis[2-(4,6-difluorophenyl)pyridine](3-methyl-pyridine-2-carboxylic acid phenylamlide) (Compound 2)

Step 1:

3-Methyl-2-picolinic acid (1.00 g, 7.29 mmol) dissolved in 25 ml of dichloromethane was charged in a dried 50 ml two-neck bottle, and thionyl chloride (0.87 g, 7.31 mmol) added to react at room temperature for 6 hours. Aniline (1.36 g, 14.60 mmol) was added to react at room temperature for 12 hours. The product was extracted by water and dichloromethane, and the organic layer dried and purified by column chromatography to obtain 3-methyl-pyridine-2-carboxylic acid phenylamide at a yield of 30%. The synthesis pathway is shown.

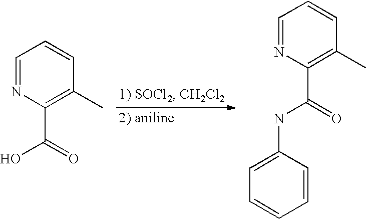

Step 2:

Dichloro bridged dimmer: [IrCl(2-(4,6-difluorophenyl) pyridine)₂]₂ (1.00 g, 0.82 mmol), 3-methyl-pyridine-2-carboxylic acid phenylamide (0.45 g, 2.12 mmol) and Na₂CO₃ (0.96 g, 9.06 mmol) were mixed and refluxed with 20 ml of ethylene glycol ethyl ether for 24 hours. The product was extracted with water and dichloromethane, and the organic layer dried and purified by column chromatography to obtain compound 2 at a yield of 10%. The synthesis pathway is shown.

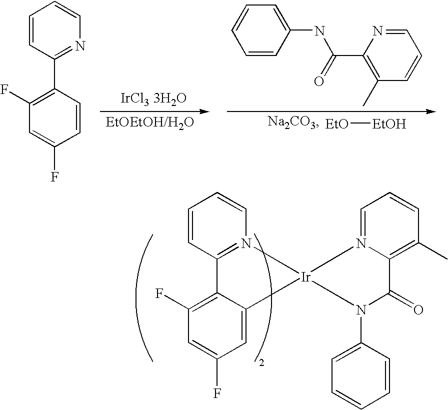

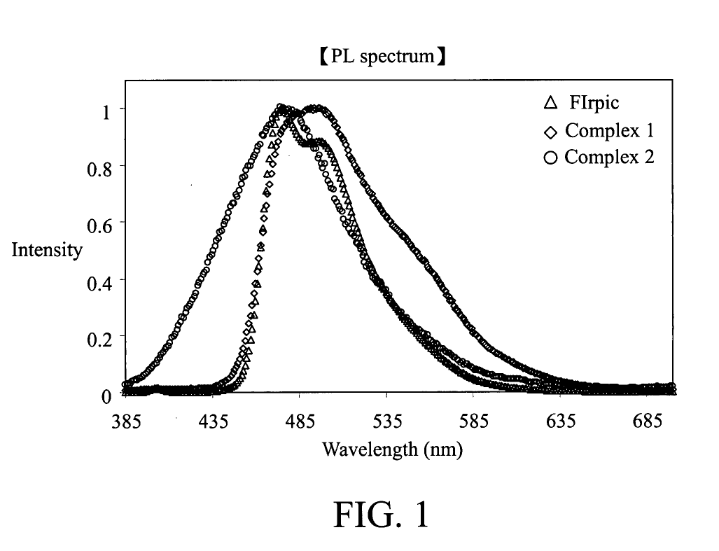

The photo luminance (PL) spectra of compounds 1 and 2 are shown in FIG. 1. It can be seen from the spectra that the maximum light emission wavelength of compound 1 is 497 nm and that of compound 2 is 476 nm. Compared to the multiple peak wavelengths of the compound FIrpic published by Mark E. Thompson, compounds 1 and 2 respectively produce only a single peak emission.

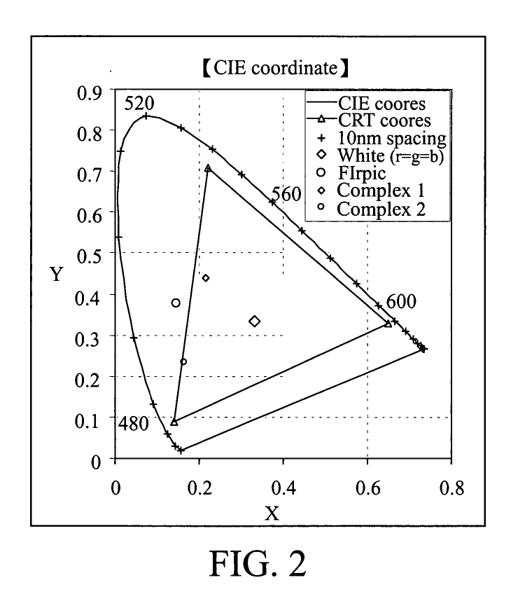

Transferring the PL spectra to CIE coordinates as shown in FIG. 2, compound 1 is (0.21, 0.44), compound 2 is (0.16, 0.23), and FIrpic is (0.14, 0.38). It can be seen from the CIE coordinate that compound 1 shifts to only green light, and compound 2 shifts to only blue light rather than the blue-green light produced by the FIrpic.

While the invention has been described by way of example and in terms of preferred embodiment, it is to be understood that the invention is not limited thereto.

What is claimed is:

1. An organometallic complex having formula (I) 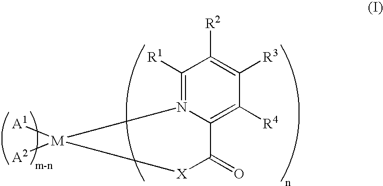
wherein
M is a transition metal;
A¹ and a² are each independently a monodentate ligand, or are covalently joined to form a bidentate ligand;
wherein when X is oxygen,
R¹, R², R³, R⁴ are each independently CN, CF₃, C₁₋₂₀ alkoxyl, or NRR′;
and when X is S or NR,
R¹, R², R³, R⁴ are each independently halogen, CN, CF₃, C₁₋₂₀ alkyl, C₅₋₇ aryl, C₁₋₂₀ alkoxyl, or NRR′; wherein R, R′ are each independently C₁₋₂₀ alkyl or C₅₋₇ aryl;
m is the valence of M; and
n is 1, 2, or 3.

2. The organometallic complex as claimed in claim 1, wherein M is Ir, Pt, Os, Re, Ru, or Rh.

3. The organometallic complex as claimed in claim 1, wherein A¹ and A² are covalently joined to form a bidentate ligand.

4. The organometallic complex as claimed in claim 3, wherein the bidentate ligand formed by A¹ and A² is 2-(4,6-difluorophenyl)pyridine.

5. The organometallic complex as claimed in claim 1, wherein when X is oxygen, one of R¹, R², R³, R⁴ is CN.

6. The organometallic complex as claimed in claim 1, wherein X is aminophenyl group.

7. The organometallic complex as claimed in claim 6, wherein one of R¹, R², R³, R⁴ is C₁₋₂₀ alkyl.

8. The organometallic complex as claimed in claim 1, wherein the organometallic complex comprises

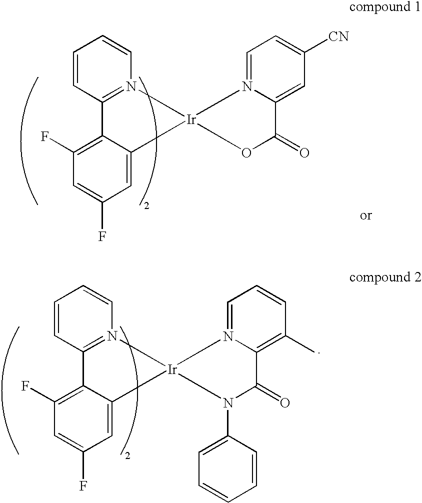

9. The organometallic complex as claimed in claim 1, wherein the organometallic complex emits light.

10. The organometallic complex as claimed in claim 1, wherein the organometallic complex emits phosphorescence.

11. The organometallic complex as claimed in claim 1, wherein the organometallic complex emits blue phosphorescence.

12. The organometallic complex as claimed in claim 1, wherein the organometallic complex has a hole transport property.

13. An organic electroluminescent device, comprising a pair of electrodes and an organic light-emitting unit disposed therebetween,
wherein the organic light-emitting unit comprises an organometallic complex having formula (I) 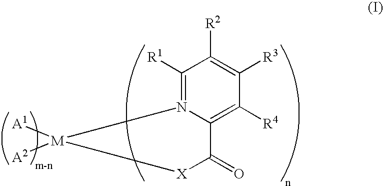
wherein
M is a transition metal;
A¹ and A² are each independently a monodentate ligand, or are covalently joined to form a bidentate ligand;
wherein when X is oxygen,
R¹, R², R³, R⁴ are each independently CN, CF₃, C₁₋₂₀ alkoxyl, or NRR′;
and when X is S or NR,
R¹, R², R³, R⁴ are each independently halogen, CN, CF₃, C₁₋₂₀ alkyl, C₅₋₇ aryl, C₁₋₂₀ alkoxyl, or NRR′; wherein R, R′ are each independently C₁₋₂₀ alkyl or C₅₋₇ aryl;
m is the valence of M; and
n is 1, 2, or 3.

14. The organometallic electroluminescent device as claimed in claim 13, wherein the organic light-emitting unit comprises an emissive layer comprising an organometallic complex having formula (I).

15. The organometallic electroluminescent device as claimed in claim 13, wherein the organic light-emitting unit comprises a hole transport layer comprising an organometallic complex having formula (I).

16. The organometallic electroluminescent device as claimed in claim 13, wherein the organic light-emitting unit comprises an electron transport layer comprising an organometallic complex having formula (I).
